(19) United States
(12) Patent Application Publication
(10) Pub. No.: US 2024/0092177 A1
(43) Pub. Date: Mar. 21, 2024

(54) METHOD FOR DISCHARGING A FUEL-CELL STACK FOR SUPPLYING POWER TO A TRACTION ELECTRIC MACHINE OF A MOTOR VEHICLE

(71) Applicant: RENAULT S.A.S, Boulogne Billancourt (FR)

(72) Inventors: David GERARD, Guyancourt (FR); Serge LOUDOT, Guyancourt (FR)

(73) Assignee: RENAULT S.A.S, Boulogne Billancourt (FR)

(21) Appl. No.: 18/256,519

(22) PCT Filed: Dec. 7, 2021
(86) PCT No.: PCT/EP2021/084644

§ 371 Date: Jun. 8, 2023

(30) Foreign Application Priority Data
Dec. 9, 2020 (FR) 2012910

(51) Int. Cl. B60L 3/04; B60L 50/75; B60L 58/30; H01M 8/04746; H01M 10/44; H01M 16/00

(52) U.S. Cl. CPC B60L 3/04; B60L 50/75; B60L 58/30; H01M 8/04753; H01M 10/44; H01M 16/006; B60L 2210/10; H01M 2220/20; H01M 2250/20; H01M 2250/402

(57) ABSTRACT

A method discharges the electrical circuit of a vehicle including at least one traction electric machine and equipped with an electrical supply network including a high-voltage battery and a hydrogen-fuel-cell stack that is associated with a voltage converter, with a high-voltage consumption network including the machine associated with an inverter and appended pieces of equipment, and with a drive module. The discharging method includes the following successive steps: stopping the vehicle, electrically disconnecting the battery from the network, interrupting the supply of hydrogen to the stack, and discharging energy from the electrical circuit into the stator winding of the machine by driving the voltage converter via the drive module.

### TECHNICAL FIELD OF THE INVENTION

The present invention relates to the field of hydrogen fuel cells.

The invention more specifically relates to a method for discharging a fuel cell following a voluntary or emergency interruption of the supply of hydrogen to the fuel cell.

### TECHNICAL BACKGROUND

Hydrogen fuel cells are used as a source of electrical energy in numerous applications, and notably in the field of transport.

Some motor vehicles, referred to as “electric” motor vehicles, are equipped with a fuel cell used in combination with a high-voltage battery to notably power the electric power chain of the motor vehicle comprising at least one electric traction machine.

More specifically, motor vehicles with a fuel cell are propelled by electricity resulting from an electrochemical reaction between hydrogen, which is stored in a tank, for example, and the oxygen contained in the air.

In such an architecture, the high-voltage battery constitutes the main power supply source and the hydrogen fuel cell constitutes the secondary or even the ancillary power source. The fuel cell therefore forms part of a “range extender system”, which is provided and designed to extend the range of the high-voltage battery.

Such an architecture constitutes a multi-energy platform and allows a smaller high-voltage battery to be installed. Indeed, the high-voltage battery is then dimensioned to ensure the “normal” use of the vehicle and the ancillary energy source is configured to ensure “exceptional” uses of the vehicle, for example, in the case of a very long journey.

This architecture, called multi-energy architecture, is advantageous for utility type motor vehicles with at least partially electric propulsion because a compromise exists between the range of the vehicle, the transportable mass and the available volume.

Motor vehicles also exist with an architecture that is made up of a high-power hydrogen fuel cell designed to directly supply the power chain of the electric motor vehicle.

In general, an interruption of the fuel supply of a hydrogen fuel cell, i.e., of hydrogen, can be caused by stopping the contact of the vehicle, it is then referred to as a voluntary or conventional stop, or else following any malfunction of the vehicle or even during an accident, and it is then referred to as an emergency stop.

Following the interruption of the supply of the fuel cell, constituting a voluntary stop or an emergency stop, the hydrogen flow rate decreases and then reaches a zero value, with the amount of residual hydrogen contained inside the fuel cell then being very low.

However, residual hydrogen capable of producing residual energy of the fuel cell is present in the volume of the “stack” of the fuel cell formed by a stack of electrochemical cells. The residual energy must be fully consumed in order for the voltage of the fuel cell to reach a zero value and thus allow the fuel cell system, and in general the vehicle, to be safeguarded.

In the prior art, systems exist that are designed for discharging the residual energy of the fuel cell until a zero value is obtained for the voltage of the fuel cell.

However, the function of discharging the residual energy inside the fuel cell is generally provided by one or more mechanical or electronic switches associated with one or more dissipative elements, such as resistors or varistors. These additional components dedicated to discharging are conventionally electrically connected in parallel with the fuel cell.

For example, document U.S. Pat. No. 5,105,142 describes a system for discharging a fuel cell by means of multiple switches and resistors electrically connected in parallel. The successive connection of parallel resistors allows the load impedance of the fuel cell to be controlled, thus forming a means for controlling discharging of the fuel cell as a function of the mass and the residual hydrogen pressure. The disadvantage of this solution is the bulk caused by the multiple electromechanical resistors and relays. Furthermore, this principle is above all dedicated to stationary applications.

Each of the documents US 2019/379070 and WO 2020/020524 proposes a discharging system made up of electromechanical relays associated with a resistor and electrically connected in parallel with the fuel cell.

However, these various systems for discharging a fuel cell have some disadvantages. Firstly, the components providing the discharging function, i.e., the combination of switches and dissipative elements, are only dedicated to this function. Any failure of these components can cause a general failure of the fuel cell system due to their electrical connection parallel to the fuel cell, with such a failure then involving high repair costs.

The invention notably proposes overcoming the aforementioned disadvantages and proposing a method for discharging the residual energy inside the fuel cell provided by a limited number of components and bulk.

### SUMMARY OF THE INVENTION

The invention proposes a method for discharging the electrical circuit of a motor vehicle comprising at least one electric traction machine of the vehicle equipped with:
an electrical power supply network comprising:
   a high-voltage battery;
   a range extender system comprising a hydrogen fuel cell that is associated with a DC-DC voltage converter itself comprising a filtering inductor traversed by a current of the filtering inductor, a primary filtering capacitor that is at the voltage of the hydrogen fuel cell, and a secondary filtering capacitor that is at the output voltage of the DC-DC voltage converter;
a high-voltage consumption network, powered by the electrical power supply network, comprising the at least one electric traction machine of the motor vehicle associated with an inverter and ancillary equipment; and
a control module.

The discharging method comprises the following successive steps:
stopping the motor vehicle;
electrically disconnecting the high-voltage battery from the high-voltage network;
interrupting the hydrogen supply of the hydrogen fuel cell; and
discharging the energy of the electrical circuit into the stator winding of the electric traction machine.

The discharging method is characterized in that the step of discharging the energy of the electrical circuit is carried out by controlling the DC-DC voltage converter by means of the control module.

According to other features of the invention:
the step of stopping the vehicle corresponds to the voluntary stopping of the motor vehicle, the step of discharging the energy of the electrical circuit comprises the following successive sub-steps:
   discharging the energy produced by consuming the residual hydrogen contained in the hydrogen fuel cell by means of the DC-DC voltage converter by controlling a discharging current by means of the control module until a predetermined voltage threshold value of the hydrogen fuel cell is reached;
   electrically disconnecting the range extender system from the high-voltage consumption network;
   discharging the energy from the capacitors of the high-voltage consumption network into the stator of the electric traction machine by means of the inverter; the step of discharging the energy of the electrical circuit comprises a sub-step, which is carried out at the same time as the two previous sub-steps, of discharging the energy of the primary and secondary filtering capacitors of the DC-DC voltage converter by controlling the current of the filtering inductor by means of the control module;
the step of stopping the vehicle corresponds to an emergency stop of the motor vehicle, prior to the step of discharging the energy of the electrical circuit, the method for discharging the electrical circuit comprises a step of electrically disconnecting the range extender system from the high-voltage network that is carried out simultaneously with the step of electrically disconnecting the high-voltage battery from the high-voltage consumption network, the step of discharging the energy of the electrical circuit comprises the following sub-steps:
   discharging the energy of the capacitors of the high-voltage consumption network into the stator of the electric traction machine by means of the inverter;
   the step of discharging the energy of the electrical circuit comprises a sub-step, which is carried out at the same time as the previous sub-step, of discharging the residual hydrogen contained in the hydrogen fuel cell and of discharging the energy of the primary and secondary filtering capacitors of the DC-DC voltage converter by controlling the current of the filtering inductor by means of the control module;
the process for controlling the current of the filtering inductor by means of the control module is configured to reach a low value of the voltage of the hydrogen fuel cell by means of a series of n self-discharging cycles of the primary and secondary filtering capacitors of the range extender system;
each self-discharging cycle of the primary and secondary filtering capacitors of the range extender system comprises:
   a step of controlling the DC-DC voltage converter of the range extender system by means of the control module of the DC-DC voltage converter in order to obtain a positive value of the current of the filtering inductor, with the positive value of the current of the filtering inductor supplied by the primary filtering capacitor to the secondary filtering capacitor causing:
      a reduction of the value of the voltage of the hydrogen fuel cell; and
      an increase of the value of the output voltage of the DC-DC voltage converter; and
   a step of controlling the DC-DC voltage converter of the range extender system by means of the control module in order to obtain a negative value of the current of the filtering inductor, with the negative value of the current of the filtering inductor supplied by the secondary filtering capacitor to the primary filtering capacitor causing:
      a reduction of the value of the output voltage of the DC-DC voltage converter; and
      an increase of the value of the voltage of the primary filtering capacitor;
and the process for controlling the current of the filtering inductor by means of the control module is configured so that the value of the voltage of the hydrogen fuel cell at the end of a cycle of n+1 self-discharging cycles is less than the value of the voltage of the hydrogen fuel cell at the end of the cycle of n self-discharging cycles.

### BRIEF DESCRIPTION OF THE FIGURES

Further features and advantages of the invention will become apparent from reading the following detailed description, which can be understood with reference to the accompanying drawings, in which:

FIG. 1 is an electrical diagram of the architecture of an electric motor vehicle comprising a range extender system according to the invention, during normal operation of the fuel cell;

FIG. 2 is an electrical diagram of the architecture of an electric motor vehicle according to FIG. 1, during the operation of discharging the residual energy of the fuel cell following voluntary stopping of the supply of the fuel cell:

FIG. 3 is a diagram of the steps of the method for discharging the electrical circuit of the electric motor vehicle following conventional stopping of the supply of the fuel cell;

FIG. 4 is a detailed electric diagram of the range extender system according to FIG. 2, during the operation of discharging the residual energy of the fuel cell following an emergency stop of the supply of the fuel cell;

FIG. 5 is a diagram of the steps of the method for discharging the electrical circuit of the electric motor vehicle following an emergency stop of the supply of the fuel cell;

FIG. 6 is a graphical representation of the process for self-discharging the primary and secondary filtering capacitors of the range extender system following an emergency stop of the supply of the fuel cell.

### DETAILED DESCRIPTION OF THE INVENTION

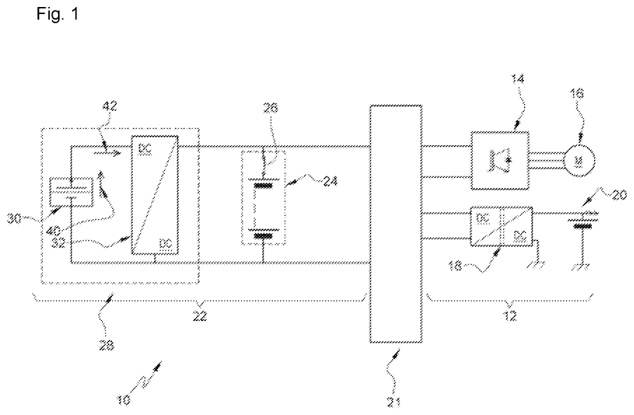

Throughout the following description, identical, similar or like elements will be designated using the same alphanumeric references. FIG. 1 is a diagram of the electrical circuit 10 of the architecture of an electric motor vehicle comprising a high-voltage network 12, called consumption network, that is electrically powered by an electrical power supply network 22.

The electrical power supply network 22 is made up of a main power supply source and an ancillary power supply source that are electrically connected to each other in parallel.

The electrical power supply network 22 is made up of a high-voltage battery 24 constituting the main power source and of a range extender system 28 constituting the ancillary power source. The range extender system 28 comprises a hydrogen fuel cell 30 associated with a DC-DC voltage converter 32 of the range extender system 28 arranged at the output of the hydrogen fuel cell 30.

The DC-DC voltage converter 32 of the range extender system 28 constitutes a voltage booster for adapting the value of the voltage supplied by the hydrogen fuel cell 30 to the voltage of the high-voltage consumption network 12 of the electric motor vehicle.

The high-voltage battery 24 is the main source of electrical energy and mainly supplies the high-voltage consumption network 12. Indeed, the high-voltage battery 24 is dimensioned to ensure the normal use of the “electric” motor vehicle that is punctuated by regular phases of recharging the high-voltage battery 24.

The high-voltage battery 24 is equipped with at least one main switch 26 of the high-voltage battery 24 provided to electrically connect or disconnect the high-voltage battery 24 of the high-voltage consumption network 12 between a position for connecting or disconnecting the main switch 26 of the high-voltage battery 24.

The hydrogen fuel cell 30 associated with the DC-DC voltage converter 32 of the range extender system 28 constitutes an additional energy source installed in the electrical power supply network 22 initially made up of the high-voltage battery 24.

The hydrogen fuel cell 30 that is at a voltage value 40 provides a current 42 of the hydrogen fuel cell 30.

The range extender system 28 is provided to extend the range of use of the high-voltage battery 24.

The high-voltage consumption network 12 supplies an electric traction machine 16 belonging to the power chain of the vehicle, as well as electricity-consuming elements such as ancillary equipment 20.

Conventionally, the electric traction machine 16 comprises a stator associated with a stator winding of the electric traction machine 16.

The electrical power supply network 22 of the electric motor vehicle is electrically connected to the high-voltage consumption network 12 by means of a distribution box 21.

An inverter 14 is electrically arranged upstream of the electric traction machine 16 while providing a voltage regulator role in order to thus provide the voltage required to power the electric traction machine 16.

The ancillary equipment 20 is electrically connected to the distribution box 21 via a voltage converter 18 of the high-voltage consumption network 12 provided to decrease the voltage and thus supply the ancillary equipment 20 with low voltage.

The distribution box 21 redistributes the high-voltage 22, on the one hand, to the inverter 14 in order to supply the electric traction machine 16 and, on the other hand, to the voltage converter 18 of the high-voltage consumption network 12 in order to supply the ancillary equipment 20. Other elements, not shown, also can be connected to the distribution box 21.

The architecture shown in FIG. 1 relates to a motor vehicle for which the power chain of the high-voltage consumption network 12 is mainly powered by the high-voltage battery 24 during the normal use of the vehicle.

When the main switch 26 of the high-voltage battery 24 is in a connection position, the high-voltage battery 24 powers the electrical power supply network 22 of the vehicle comprising the power chain. When the high-voltage battery 24 is fully discharged, the ancillary power source made up of the hydrogen fuel cell 30 is started and produces the electrical power required to advance the vehicle, during normal operation of the hydrogen fuel cell 30.

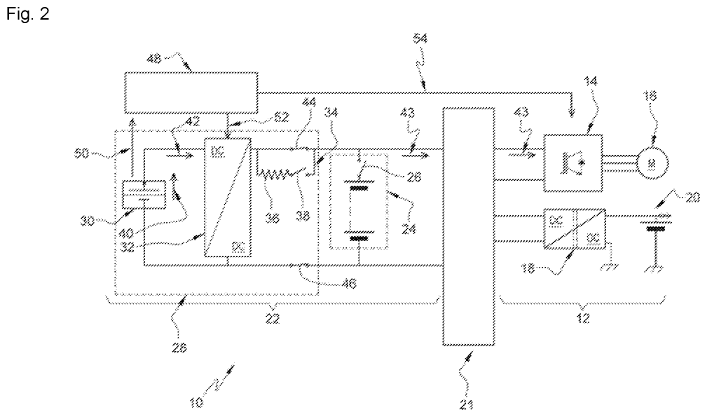

The electrical diagrams of the architecture of a vehicle of FIGS. 2 and 4 show the electrical diagram of the range extender system 28. The range extender system 28 constitutes a second power source that comprises:
a pre-charging circuit 34 comprising a pre-charging resistor 36 associated with a pre-charging switch 38 provided to ensure the connection/disconnection of the range extender system 28 to/from the electrical power supply network 22; and
two main switches, including a first main switch 44 and a second main switch 46; and
a control module 48 for the DC-DC voltage converter 32 that is notably configured to control the process for discharging the residual energy produced by the hydrogen fuel cell 30 following an interruption of the hydrogen supply of the hydrogen fuel cell 30.

The control module 48 receives information from the hydrogen fuel cell 30 defining the state 50 of the hydrogen fuel cell 30, such as, for example, the amount of residual hydrogen contained in the hydrogen fuel cell 30 and the output voltage 41 of the DC-DC voltage converter 32, which voltage is also the voltage of the high-voltage battery 24. The control module 48 is configured to, as a function of the state 50 of the hydrogen fuel cell 30, send:
a setpoint value 52 of the current 42 of the hydrogen fuel cell 30 to the DC-DC converter 32; and
a setpoint value 54 of the discharging current 43 to the inverter 14.

The DC-DC voltage converter 32 as described in detail in FIG. 4 is made up of a low-voltage input stage 66 and a high-voltage output stage 64.

The low-voltage input stage 66 comprises a primary filtering capacitor 56 that is at the voltage 40 of the hydrogen fuel cell 30 when it delivers current, and a filtering inductor 60 traversed by a current 61 of the filtering inductor 60.

The high-voltage output stage 64 comprises a secondary filtering capacitor 58 that is at the output voltage 41 of the DC-DC voltage converter 32.

Two controllable semiconductors, for example, transistors 62, are arranged between the low-voltage 66 and high-voltage 64 stages and form part of the control module 48 of the DC-DC voltage converter 32.

These components constitute a safety system that is required to isolate all the high-voltage power sources.

The whole of the electrical circuit 10 of the architecture of an at least partially electric traction motor vehicle comprises capacitors such as those present in the DC-DC voltage converter 32, the inverter 14, and other ancillary electrical components electrically connected in parallel. Each of these different capacitors has a capacitance that can be relatively high, with the capacitance being proportional to the amount of electrical charge that can be stored in the capacitor for a certain voltage.

The primary filtering capacitor 56 is designed to suppress noise beyond the DC-DC voltage converter 32 of the range extender system 28. The secondary filtering capacitor 58 is designed so as not to prevent the generation of overvoltages and therefore the generation of noise.

The pre-charging circuit 34 is therefore required because, when the filtering capacitors 56, 58 are discharged, it is dangerous to connect them to the high-voltage battery 24. The pre-charging resistor 36 and the pre-charging switch 38 are required to create a transient pre-charging state that limits the current transferred between the high-voltage battery 24 and the capacitors.

Firstly, the second main switch 46 and the pre-charging switch 38 are closed in order to electrically connect the capacitors and the high-voltage battery 24 charged at different voltages in parallel, by means of the pre-charging resistor 36, thus allowing the current to be limited.

Then, secondly, when the output voltage 41 of the DC-DC voltage converter 32 is equal to the voltage of the high-voltage battery 24, the pre-charging switch is open and the main switch 44 is closed in order to directly electrically connect the two main switches 44 and 46 in parallel, and the voltages on either side are then balanced following the transient pre-charging state.

The high-voltage battery 24 also comprises main switches and a pre-charging circuit, not shown and similar to the main switches 44, 46 and to the pre-charging circuit 34 of the range extender system 28 provided to ensure the connection/disconnection of the high-voltage battery 24 to/from the electrical power supply network 22.

FIGS. 2 and 4 show the electrical diagram of the architecture of a vehicle following the interruption of the hydrogen supply of the hydrogen fuel cell 30 following a step E0 of stopping the motor vehicle.

The interruption of the supply to the hydrogen fuel cell 30 illustrated in FIG. 2 is caused by stopping the contact of the electric motor vehicle, and it is then referred to as a conventional or a voluntary stop.

The interruption of the supply to the hydrogen fuel cell 30 illustrated in FIG. 4 is caused, for example, by a malfunction of the vehicle or following an accident, and this is then referred to as an emergency stop. In these two cases, following the interruption of the hydrogen supply of the hydrogen fuel cell 30, the hydrogen flow decreases and then reaches a zero value. However, a very small amount of residual hydrogen remains contained inside the hydrogen fuel cell 30. The residual energy produced by the hydrogen fuel cell 30 using this residual amount of hydrogen must be fully consumed in order for the voltage 40 of the hydrogen fuel cell 30 to reach a zero value.

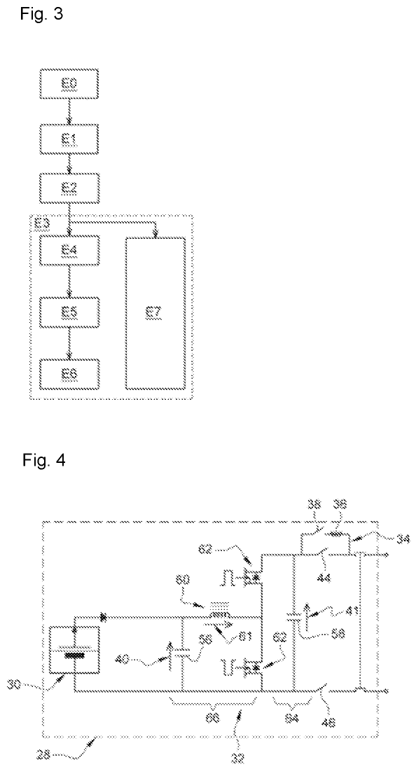

FIG. 3 is a diagram of the steps of the method for discharging the electrical circuit 10 during a voluntary stop according to the invention, as shown in FIG. 2. The successive steps of the discharging method are as follows:
E1: electrically disconnecting the high-voltage battery 24 from the high-voltage consumption network 12 by opening the main switches 26 of the high-voltage battery 24;
E2: interrupting the hydrogen supply of the hydrogen fuel cell 30 by closing a hydrogen supply valve;
E3: discharging the energy of the electrical circuit 10 into the stator of the electric traction machine 16.

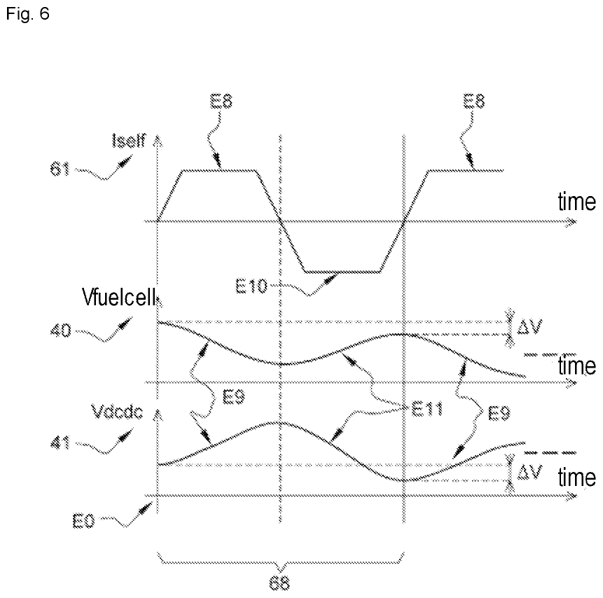

The above step E3 comprises the following sub-steps:
E4: discharging the residual energy of the hydrogen fuel cell 30 by the DC-DC voltage converter 32 controlled by the control module 48 of the DC-DC voltage converter 32 that controls the discharging current 43 until it reaches a predetermined threshold value of the voltage 40 of the hydrogen fuel cell 30;
E5: electrically disconnecting the range extender system 28 from the high-voltage consumption network 12 by opening the first and second main switches 44, 46 of the range extender system 28;
E6: discharging the energy stored in the capacitors of the high-voltage consumption network 12 into the stator of the electric traction machine 16 via the inverter 14;
E7: a sub-step, which is carried out at the same time as the above sub-steps E5 to E6, of discharging the residual energy of the hydrogen fuel cell 30 and the energy stored in the primary 56 and secondary 58 filtering capacitors of the DC-DC voltage converter 32 controlled by the control module 48 of the DC-DC voltage converter 32 that controls the current 61 of the filtering inductor 60 according to the self-discharging procedure illustrated in FIG. 6.

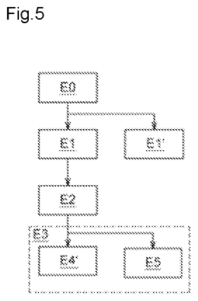

FIG. 5 is a diagram of the steps of the method for discharging the electrical circuit 10 during an emergency stop according to the invention shown in FIG. 4. The successive steps of the discharging method are as follows:
E1 and E1′: these two steps are carried out simultaneously, E1 for electrically disconnecting the high-voltage battery 24 from the high-voltage consumption network 12 by opening the main switches 26 of the high-voltage battery 24, and E1′ for electrically disconnecting the range extender system 28 from the high-voltage consumption network 12 by opening the first and second switches 44, 46 of the range extender system 28;
E2: interrupting the hydrogen supply of the hydrogen fuel cell 30 by closing a hydrogen supply valve;
E3: discharging the energy of the electrical circuit 10, with step E3 comprising the following sub-steps:
   E4′: the inverter 14 discharging the energy stored in the capacitors of the high-voltage consumption network 12 into the stator of the electric traction machine 16;
   E5′: a sub-step, which is carried out at the same time as the sub-step E4′, of discharging the residual hydrogen contained in the hydrogen fuel cell 30 and of discharging the energy stored in the primary 56 and secondary 58 filtering capacitors of the DC-DC voltage converter 32 controlled by the control module 48 of the DC-DC voltage converter 32 that controls the current 61 of the filtering inductor 60 according to the self-discharging procedure described in FIG. 6.

In the discharging method following an emergency stop described above, steps E1 and E1′ form a single disconnection step. Indeed, from a safety perspective, immediately cutting off all the energy sources is stipulated in order to eliminate all types of dangers (such as, for example, sustaining the initiation of a fire by powering a short circuit via damaged cable insulation, creating a hot spot). As a result, the disconnection orders for the hydrogen fuel cell 30 and for the high-voltage battery 24 arrive simultaneously.

FIG. 6 is a graphical representation of the process for self-discharging the primary 56 and secondary 58 filtering capacitors of the range extender system carried out in steps E7 and E4′.

Discharging the residual energy of the hydrogen fuel cell 30 is carried out by energy losses generated by successive round trips of energy between the primary 56 and secondary 58 filtering capacitors by controlling the current 61 of the filtering inductor 60, with a round trip forming a self-discharging cycle 68.

The process for self-discharging the primary 56 and secondary 58 filtering capacitors of the range extender system 28 represented by the diagram of FIG. 6 comprises the following steps:
First self-discharging cycle 68:
State of the electrical circuit 10 at t=0:
   current 61 of the filtering inductor 60: I_{self}=0;
   voltage 40 of the hydrogen fuel cell 30: V_{pac}=V_{max cycle 1};
   output voltage 41 of the DC-DC voltage converter 32: V_{dcdc}=V_{min cycle 1};
E8: controlling the DC-DC voltage converter 32 of the range extender system 28 by means of the control module 48 of the DC-DC voltage converter 32 to obtain a positive value of the current 61 of the filtering inductor 60;
E9: positive current 61 of the filtering inductor 60 supplied by the primary filtering capacitor 56 and the fuel cell 30, which are at the same voltage 40, to the secondary filtering capacitor 58, which is at the output voltage 41 of the DC-DC voltage converter 32:
   decreasing the value of the voltage 40 of the hydrogen fuel cell 30;
   increasing the value of the output voltage 41 of the DC-DC voltage converter 32 because the value of the current 61 of the filtering inductor 60 is positive.
State at t=½ self-discharging cycle 68:
   current 61 of the filtering inductor 60: I_{self}=0;
   voltage 40 of the hydrogen fuel cell 30: V_{pac}=V_{pac min 1};
   output voltage 41 of the DC-DC voltage converter 32: V_{dcdc}=V_{dcdc max 1};
E10: controlling the DC-DC voltage converter 32 of the range extender system 28 via the control module 48 of the DC-DC voltage converter 32 to obtain a negative value of the current 61 of the filtering inductor 60;
E11: negative current 61 of the filtering inductor 60 supplied by the secondary filtering capacitor 58 to the primary filtering capacitor 56:
   a reduction of the value of the output voltage 41 of the DC-DC voltage converter 32;
   an increase of the value of the voltage 40 of the primary capacitor 56 because the value of the current 61 of the filtering inductor 60 is negative.
State at t=1 self-discharging cycle 68:
   current 61 of the filtering inductor 60: I_{self}=0;
   voltage 40 of the hydrogen fuel cell 30: V_{pac}=V_{pac max 2};
   output voltage 41 of the DC-DC voltage converter 32: V_{dcdc}=V_{dcdc min 2}, with V_{pac max 2}<V_{pac max 1}, V_{dcdc min 2}<V_{dcdc min 1}

V_{pac max 1}−V_{pac max 2}=V_{pac} and V_{dcdc min 1}−V_{dcdc min 2}=ΔV_{dcdc}.

For each self-discharging cycle 68, the voltage 40 of the hydrogen fuel cell 30 decreases and, following several self-discharging cycles 68 with a duration of the order of a few milliseconds, the hydrogen fuel cell 30 is fully discharged. The duration for fully discharging the hydrogen fuel cell 30 is less than one second.

Each self-discharging cycle 68 generates energy losses in step E11 by a voltage value 40 of the hydrogen fuel cell 30 ΔV_{pac} equal to the voltage difference 40 of the hydrogen fuel cell 30 V_{pac max 1} at the beginning and at the end V_{pac max 2} of the same self-discharging cycle 68. Several self-discharging cycles 68 will succeed each other until a low voltage value 40 of the fuel cell 30 is reached.

According to one embodiment of the invention, the DC-DC voltage converter 32 is configured to obtain a voltage value of the primary 56 and secondary 58 filtering capacitors of less than 60 volts, i.e., a safety voltage value.

The two transistors 62 of the control module 48 of the DC-DC voltage converter 32 are configured to slave the current 61 of the filtering inductor 60 between the low-voltage input stage 66 and the high-voltage output stage 64 of the DC-DC voltage converter 32 in a positive direction or a negative direction and to a setpoint value of the current 61 of the filtering inductor 60 as a function of the voltage values 40, 41 of the primary 56 and secondary 58 filtering capacitors. The control module 48 of the DC-DC voltage converter 32 is configured to control the successive round trips of energy between the primary 56 and secondary 58 filtering capacitors by imposing the setpoint value of the current 61 of the filtering inductor 60.

Consequently, it is the DC-DC voltage converter 32 that accumulates the generated energy losses and that controls the round trips of energy between the low-voltage input stage 66 and the high-voltage output stage 64 of the DC-DC voltage converter 32.

This procedure for self-discharging the primary 56 and secondary 58 filtering capacitors is also used during a voluntary stop of the supply of the hydrogen fuel cell 30 corresponding to step E7.

Moreover, during a voluntary stop of the supply of the hydrogen fuel cell 30, this self-discharging procedure is also adapted to step E4 for controlling the discharging current 43 of the residual energy as a function of the loss of hydrogen pressure inside the hydrogen fuel cell 30, and therefore for ensuring an optimal electrochemical reaction despite the decreasing amount of hydrogen present inside the hydrogen fuel cell 30.

In the present invention, the function of discharging “residual” energy of the hydrogen fuel cell 30 is provided by the DC-DC voltage converter 32 constituting an internal discharging means.

Discharging the residual hydrogen contained inside the hydrogen fuel cell 30 by a structural element of the range extender system 28 allows the initial architecture of the range extender system 28 to be preserved. The DC-DC voltage converter 32 thus by itself fulfils the function of discharging the hydrogen fuel cell 30 and dispenses with the addition of components dedicated to the discharging function, such as switches and additional dissipative elements.

Such an architecture also ensures precise control of the discharging current 43 by allowing the residual energy of the hydrogen fuel cell 30 to be discharged directly as a function of the remaining amount of residual energy (mass and pressure). Consequently, the current is controlled as a function of the partial hydrogen pressures remaining inside the hydrogen fuel cell 30, so as to obtain the best stoichiometry and thus promote the lifetime of the hydrogen fuel cell 30.

### KEY

10: electrical circuit
12: high-voltage consumption network
14: inverter
16: electric traction machine
18: voltage converter of the high-voltage consumption network
20: ancillary equipment
21: distribution box
22: electrical power supply network
24: high-voltage battery
26: main switch of the high-voltage battery
28: range extender system
30: hydrogen fuel cell
32: DC-DC voltage converter of the range extender system
34: pre-charging circuit
36: pre-charging resistor
38: pre-charging switch
40: voltage of the fuel cell
41: output voltage of the DC-DC voltage converter
42: current of the fuel cell
43: discharging current
44: first main switch
46: second main switch
48: control module of the DC-DC voltage converter
50: state of the fuel cell
52: current setpoint of the fuel cell
54: discharging current setpoint
56: primary filtering capacitor
58: secondary filtering capacitor
60: filtering inductor
61: filtering inductor current
62: transistor
64: high-voltage output stage
66: low-voltage input stage
68: self-discharging cycle

1-6. (canceled)

7. A method for discharging an electrical circuit of a motor vehicle comprising at least one electric traction machine of the vehicle equipped with:
an electrical power supply network comprising:
a high-voltage battery;
a range extender system comprising a hydrogen fuel cell that is associated with a DC-DC voltage converter that comprises a filtering inductor traversed by a current of the filtering inductor, a primary filtering capacitor that is at the voltage of the hydrogen fuel cell, and a secondary filtering capacitor that is at the output voltage of the DC-DC voltage converter;
a high-voltage consumption network, powered by the electrical power supply network, comprising the at least one electric traction machine of the motor vehicle associated with an inverter and ancillary equipment; and
a control module,
the discharging method comprising:
stopping the motor vehicle;
electrically disconnecting the high-voltage battery from the high-voltage consumption network;
interrupting a hydrogen supply of the hydrogen fuel cell; and
discharging energy of the electrical circuit into a stator winding of the electric traction machine,
wherein the discharging the energy of the electrical circuit is carried out by controlling the DC-DC voltage converter via the control module.

8. The method for discharging the electrical circuit as claimed in claim 7, wherein:
the stopping the vehicle corresponds to a voluntary stopping of the motor vehicle,
the discharging the energy of the electrical circuit comprises:
discharging energy produced by consuming residual hydrogen contained in the hydrogen fuel cell by the DC-DC voltage converter by controlling a discharging current by the control module until a predetermined voltage threshold value of the hydrogen fuel cell is reached;
electrically disconnecting the range extender system from the high-voltage consumption network;
discharging the energy from the capacitors of the high-voltage consumption network into the stator of the electric traction machine by the inverter; and
discharging, at the same time as the electrically disconnecting the range extender system and the discharging the energy from the capacitors of the high-voltage consumption network, the energy of the primary and secondary filtering capacitors of the DC-DC voltage converter by controlling the current of the filtering inductor by the control module.

9. The method for discharging the electrical circuit of a motor vehicle as claimed in claim 8, wherein a process for controlling the current of the filtering inductor by the control module is configured to reach a low value of the voltage of the hydrogen fuel cell by a series of n self-discharging cycles of the primary and secondary filtering capacitors of the range extender system.

10. The method for discharging the electrical circuit of a motor vehicle as claimed in claim 9, wherein each self-discharging cycle of the primary and secondary filtering capacitors of the range extender system comprises:
controlling the DC-DC voltage converter of the range extender system by the control module of the DC-DC voltage converter in order to obtain a positive value of the current of the filtering inductor, with the positive value of the current of the filtering inductor supplied by the primary filtering capacitor to the secondary filtering capacitor causing:
a reduction of the value of the voltage of the hydrogen fuel cell; and
an increase of a value of the output voltage of the DC-DC voltage converter; and
controlling the DC-DC voltage converter of the range extender system by the control module in order to obtain a negative value of the current of the filtering inductor, with the negative value of the current of the filtering inductor supplied by the secondary filtering capacitor to the primary filtering capacitor causing:
a reduction of the value of the output voltage of the DC-DC voltage converter; and
an increase of the value of the voltage of the primary filtering capacitor.

11. The method for discharging the electrical circuit of a motor vehicle as claimed in claim 10, wherein the process for controlling the current of the filtering inductor by the control module is configured so that the value of the voltage of the hydrogen fuel cell at an end of a cycle of n+1 self-discharging cycles is less than the value of the voltage of the hydrogen fuel cell at an end of the cycle of n self-discharging cycles.

12. The method for discharging the electrical circuit as claimed in claim 7, wherein:
the stopping the vehicle corresponds to an emergency stop of the motor vehicle,
the method for discharging the electrical circuit further comprises electrically disconnecting the range extender system from the high-voltage network that is carried out simultaneously with the electrically disconnecting the high-voltage battery from the high-voltage consumption network,
the discharging the energy of the electrical circuit comprises discharging the energy of the capacitors of the high-voltage consumption network into the stator of the electric traction machine by the inverter;
the discharging the energy of the electrical circuit comprises discharging, at the same time as the discharging the energy of the capacitors of the high-voltage consumption network, the residual hydrogen contained in the hydrogen fuel cell and discharging the energy of the primary and secondary filtering capacitors of the DC-DC voltage converter by controlling the current of the filtering inductor by the control module.

13. The method for discharging the electrical circuit of a motor vehicle as claimed in claim 12, wherein a process for controlling the current of the filtering inductor by the control module is configured to reach a low value of the voltage of the hydrogen fuel cell by a series of n self-discharging cycles of the primary and secondary filtering capacitors of the range extender system.

14. The method for discharging the electrical circuit of a motor vehicle as claimed in claim 13, wherein each self-discharging cycle of the primary and secondary filtering capacitors of the range extender system comprises:
controlling the DC-DC voltage converter of the range extender system by the control module of the DC-DC voltage converter in order to obtain a positive value of the current of the filtering inductor, with the positive value of the current of the filtering inductor supplied by the primary filtering capacitor to the secondary filtering capacitor causing:
a reduction of the value of the voltage of the hydrogen fuel cell; and
an increase of a value of the output voltage of the DC-DC voltage converter; and
controlling the DC-DC voltage converter of the range extender system by the control module in order to obtain a negative value of the current of the filtering inductor, with the negative value of the current of the filtering inductor supplied by the secondary filtering capacitor to the primary filtering capacitor causing:
a reduction of the value of the output voltage of the DC-DC voltage converter; and
an increase of the value of the voltage of the primary filtering capacitor.

15. The method for discharging the electrical circuit of a motor vehicle as claimed in claim 14, wherein the process for controlling the current of the filtering inductor by the control module is configured so that the value of the voltage of the hydrogen fuel cell at an end of a cycle of n+1 self-discharging cycles is less than the value of the voltage of the hydrogen fuel cell at an end of the cycle of n self-discharging cycles.
